(19) United States
(12) Patent Application Publication
(10) Pub. No.: US 2014/0143015 A1
(43) Pub. Date: May 22, 2014

(54) Methods and Systems for Providing a Personal Consumer Product Evaluation Engine

(71) Applicant: Beverage Analytics, Inc., Los Altos, CA (US)

(72) Inventor: Charles Killam, Los Altos, CA (US)

(73) Assignee: Beverage Analytics, Inc., Los Altos, CA (US)

(21) Appl. No.: 14/083,577

(22) Filed: Nov. 19, 2013

Related U.S. Application Data
(60) Provisional application No. 61/729,082, filed on Nov. 21, 2012.

(51) Int. Cl. G06Q 30/02

(52) U.S. Cl. CPC G06Q 30/0202
USPC 705/7.31

(57) ABSTRACT

A system and method for predicting the preference of a user product consumer for a consumer product, e.g., a wine, which may comprise collecting in a database consumer product preference data relating to the prediction of a preference of the user from at least one of the user and a separate group of product consumers; receiving from the user a request for a prediction of the preference of the user for one of a consumer product and a pre-selected set of related consumer products; analyzing the collected preference data against previously collected data specific to one of the consumer product and the pre-selected set of consumer products; calculating a predicted preference rating; and receiving and storing a preference rating based upon the user having utilized the one of the consumer product and the pre-selected set of consumer products and including the received preference rating in the product preference data.

### RELATED CASES

The present application claims priority to U.S. Provisional Patent Application No. 61/729,082, filed on Nov. 21, 2012, entitled METHODS AND SYSTEMS FOR PROVIDING A PERSONAL SOMMELIER, the disclosure of which is incorporated by reference in its entirety for all purposes, as if repeated verbatim in the present application, including the Specification, Drawing and Claims, is any.

### FIELD OF DISCLOSED SUBJECT MATTER

The disclosed subject matter relates to methods, systems and software (applications program) for providing a personal consumer product preference rating, e.g., providing a personal sommelier for wine as the consumer product. More particularly, such methods, systems and software can be utilized to provide a prediction as to a person's inclination as to one or more identified consumer products, e.g., wines.

### INCORPORATION BY REFERENCE

All patents, published patent applications and other references disclosed herein are hereby expressly incorporated by reference in their entireties and for all purposes, as if the disclosure, including any drawing(s) and/or claims were copied verbatim in the present application.

### BACKGROUND

A traditional method for identifying a good wine(s) to a consumer is to have wine connoisseurs provide wine ratings. This traditional method for identifying good wines, however, has been proven in multiple studies not to correspond to consumer preferences (e.g., Omar Gokcekus & Dennis Nottebaum's “The Buyer's Dilemma—Whose Ratings Should A Wine Drinker Pay Attention to?”). The website Likelii.com asks a user some questions regarding food or drink preferences and then recommends on line types and brands of wine for purchase by the user.

Therefore there is a continuing need to provide methods, systems and/or software for providing a personal sommelier that can provide a prediction to a person as to that person's preference towards a wine they are considering to consume. It thus would be desirable to provide such methods, systems and/or software that are configured and arranged so that such a prediction can be made with a high degree of accuracy as to the given person's inclination, e.g., as to the wine being considered for consumption.

### SUMMARY

The disclosed subject matter features methods, systems and/or software for providing a personal sommelier that can provide a prediction to a person as to that person's preference towards, e.g., one or more identified wines or an identified set of wines. Such methods, systems and/or software of the disclosed subject matter preferably are configured and arranged so that such a prediction as to the new wine has a high degree of accuracy as to the given person's inclination as to the one or more identified wines or an identified set of wines.

In one aspect of the disclosed subject matter, there is featured a method for providing a prediction to a person as to that person's preference towards an identified set of wines. Such a method includes collecting wine preference data such as that for previously tasted or consumed wine; analyzing the collected wine preference data against a multitude of previously collected data points; and returning to the person a prediction of the person's inclination to the identified set of wines. The identified set of wines can include one or more identified wines. The method also can include the person providing an evaluation for each of the one or more identified wines of the identified set that they have consumed or tasted for inclusion in the wine preference data.

In further embodiments of such wine prediction methods, at least some of the wine preference data being collected is obtained using a web application. Also, such wine preference data is one or both of individual wine preference data unique to the person and group wine preference data obtained from a population group.

According to another aspect of the disclosed subject matter, there is featured a method for providing a prediction to a person as to that person's preference towards one or more identified wines, such as a wine(s) that the person is considering for consumption/drinking. Such a method includes collecting wine preference data such as that for previously tasted or consumed wine; identifying the one or more wines, analyzing the collected wine preference data against a multitude of previously collected data points specific to each of the identified one or more wines; and returning to the person a prediction of the person's inclination as to each of the one or more wines. The method also includes the person providing an evaluation for each of the one or more identified wines that they have consumed or tasted for inclusion in the wine preference data.

In further embodiments of such wine prediction methods, at least some of the wine preference data being collected is obtained using a web application. Also, such wine preference data is one or both of individual wine preference data unique to the person and data obtained from a population group.

Also featured are systems and/or software embodying such a method.

Further featured can be a computer readable storage medium on which can be stored an applications program including instructions, criteria and/or code segments for carrying out the steps of the methods as herein described.

Although the methods of the claimed subject matter are described in connection with a specific alcoholic beverage (wine) this shall not be considered limiting. It is contemplated and thus within the scope of the claimed subject matter for the methods of the claimed subject matter to be adapted to provide such predictions for any beverage whether alcoholic or non-alcoholic and also for foods or even other types of consumer products.

Other aspects and embodiments of the claimed subject matter are discussed below.

According to aspects of the claimed subject matter a computer readable medium can mean any article of manufacture that contains data that can be read by a computer. Such non-transitory computer readable media can include but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; or paper media, such as punched cards and paper tape. What those skilled in the art would understand to constitute a computing device, machine readable media storing software for execution on a computing device and the software itself, etc. is discussed in more detail at the end of the present application.

It will be understood by those skilled in the art that a system and method is disclosed for predicting the preference of an individual user product consumer for a consumer product, e.g. acting as a personal sommelier for wines as the consumer product, which may comprise: collecting in a consumer product preference data database, via a computing device, consumer product preference data relating to the prediction of a preference of the individual user product consumer for the consumer product from at least one of the individual user product consumer and a separate group of individual product consumers; receiving, via the computing device, from the individual user product consumer a request for a prediction of the preference of the individual user product consumer for one of a consumer product and a pre-selected set of related consumer products; analyzing, via the computing device, the collected consumer product preference data against previously collected data specific to one of the consumer product and the pre-selected set of consumer products; calculating, via the computing device, a prediction of a preference rating for the individual user product consumer as to the preference of the individual user product consumer for the one of the consumer product and the preselected set of consumer products; and receiving and storing, via the computing device, a preference rating for the individual user product consumer based upon the individual user product consumer having utilized the one of the consumer product and the pre-selected set of consumer products and including the received individual user product consumer preference rating in the consumer product preference data.

The system and method may further comprise the consumer product comprising a wine. The system and method may comprise calculating, via a computing device, utilizing a statistical individual user consumer product preference evaluation equation unique to the individual user product consumer. The system and method may comprise receiving an individual user product consumer preference rating and storing the rating in the consumer product preference data and updating the individual user consumer product preference evaluation equation unique to the individual user product consumer based on such input. At least some of the consumer product preference data collected in the consumer product preference data database may be obtained through a website application.

The system and method may further comprise, wherein the consumer product preference data comprises one of individual user consumer product preference data unique to the individual user product consumer and data obtained from a population group of consumer product consumers. The individual user consumer product preference evaluation equation may comprise a linear regression analysis equation. The consumer product preference data database may comprise a cloud-based relational database, which may comprise data specific to each of the one or more pre-identified consumer products. The relational database may comprise data input from at least one of a source of consumer data, producer data, distributor data, government data, internet data and retailer data.

Also disclosed is a machine readable medium storing instructions which, when executed by a computing device, cause the computing device to perform a method, which method may comprise: collecting in a consumer product preference data database consumer product preference data relating to the prediction of a preference of the individual user product consumer for the consumer product from at least one of the individual user product consumer and a separate group of individual product consumers; receiving from the individual user product consumer a request for a prediction of the preference of the individual user product consumer for one of a consumer product and a pre-selected set of related consumer products; analyzing the collected consumer product preference data against previously collected data specific to one of the consumer product and the pre-selected set of consumer products; calculating a prediction of a preference rating for the individual user product consumer as to the preference of the individual user product consumer for the one of the consumer product and the preselected set of consumer products; and receiving and storing a preference rating for the individual user product consumer based upon the individual user product consumer having utilized the one of the consumer product and the pre-selected set of consumer products and including the received individual user product consumer preference rating into the consumer product preference data.

### BRIEF DESCRIPTION OF THE DRAWING

For a fuller understanding of the nature and desired objects of the claimed subject matter, reference can be made to the following detailed description taken in conjunction with the accompanying drawing figures wherein like reference character denote corresponding parts throughout the several views and wherein:

FIG. 1 is an illustrative exemplary view of various data sources or databases usable with the claimed subject matter, according to aspects of the claimed subject matter.

FIG. 2 is an illustrative view illustrating the flow of consumer information, according to aspects of the claimed subject matter; and

FIG. 3 is an illustrative view illustrating the flow of a process according to aspects of the claimed subject matter.

### DETAILED DESCRIPTION

In its broadest aspects, the claimed subject matter provides methods, systems and/or software (applications programs) for providing a personal sommelier that can provide a prediction to a person as to that person's preference towards, as an example, an identified set of things, e.g., wines, where the identified set can include one or more identified things, e.g., wines. Such methods, systems and/or software of the claimed subject matter preferably can be configured and arranged so that such a prediction has a high degree of accuracy as to the given person's inclination as to, e.g., the wine being considered for consumption.

The claimed subject matter provides a method as well as software and systems embodying such method(s) of the claimed subject matter, which can include collecting consumer's wine preference data such as via a web application and analyzing (e.g., running statistical analysis) on wine preference data against a multitude of previously collected data points specific to each wine. Such wine preference data can be one or both of individual wine preference data unique to the person or individual consumer and data obtained from a population group.

Such methods also can include returning to the individual consumer (i.e., a person) accurate predictions on the consumer's inclinations towards each of the one or more identified wines making up the identified set of wines. In further aspects/embodiments of the claimed subject matter, such methods also include having the person who has tasted, i.e., consumed or otherwise utilized the consumer product, e.g., consuming at least some of the wine, providing an evaluation, e.g., for each of the one or more identified wines consumed or tasted by the person for its appropriate inclusion in the wine preference data for each wine.

In an embodiment of the claimed subject matter, such methods can further include identifying or pre-identifying one or more wines and analyzing the wine preference data against a multitude of previously collected data points specific to for each of these one or more pre-identified wines. Also, such returning of a prediction could provide a prediction on the consumer's inclinations towards each of these one or more pre-identified wines. In further embodiments of the claimed subject matter, such methods also can include having the person who has tasted, consumed or drunk at least some of the pre-identified wines, provide an evaluation for each of the one or more pre-identified wines consumed or tasted by the person for its appropriate inclusion in the wine preference data for each wine.

Although the claimed subject matter is described herein with reference to a specific alcoholic beverage (wine) this shall not be considered limiting. It is within the scope of the claimed subject matter for the methods, systems and software of the claimed subject matter to be adapted to provide such predictions for any beverage whether alcoholic or non-alcoholic or for foods or even other consumer products.

The claimed subject matter, in one embodiment, provides a system and process for gathering, cleaning, standardizing, unifying and populating a cloud-based, relational database with data from various sources and/or databases. Such sources and/or databases include, but are not limited to government sources, wine suppliers, wine distributors, wine retailers, the internet and consumers.

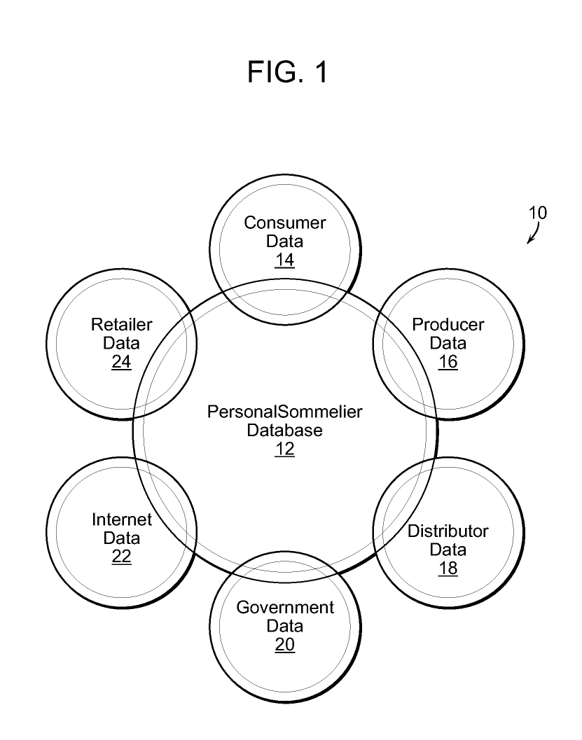

FIG. 1 shows, by way of example, a database 10 for a system in accordance with an exemplary embodiment of the claimed subject matter for collecting and storing wine preference data from different sources. As also illustrated, the database 10 for the system can include a Personal Sommelier database 12 into which data from various data sources or databases, including individual user consumer product consumer preference data, e.g., wine preference data 14 of the individual consumer, can be inputted or loaded.

As indicated above, the methods of the claimed subject matter can include analyzing (e.g., running a statistical analysis on) the wine preference data against a multitude of previously collected data points specific to each wine to be analyzed. In an embodiment of the claimed subject matter, the number of data points can be established giving consideration to a number of factors that can be appropriate for the analysis of the wine. In an embodiment (an exemplary illustrative embodiment), approximately 340 data points were derived from the six groups, however, it should be recognized that the number of groups can vary so as to be less than six or larger than six. It also should be recognized that the number of data points can be up to or about 340 or more data points.

Government sources 20 can provide, for example, weather, soil and industry data and come from such departments, bureaus and regulations as the: National Oceanic and Atmospheric Administration's National Weather Service; Department of Agriculture, Natural Resources Conservation Service; Department of the Treasury, Alcohol and Tobacco Tax and Trade Bureau; Department of Commerce; Department of Labor, Occupational Safety & Health Administration; Code of Federal Regulations: 27 CFR §4.91.

Wine producers or suppliers can provide wine producer data 16 like tasting notes, barrel details and food pairings. Such data can be uploaded into the database(s) 16 of the claimed subject matter or be inputted by wine producers/suppliers directly into the database(s) 16 of the claimed subject matter. Such data can be uploaded/inputted, for example, as new wines are brought to market from the producer or supplier as well as when data for existing wines is updated or modified.

In addition, an electronic wine list from a distributor(s) 18 can be set up using any of number of techniques or methods known in the art or hereinafter developed, to migrate continually into the Personal Sommelier database 12 of the claimed subject matter as part of the process to ensure that users of the database 12 will always find wines offered at local wine retailers such as restaurants and wine stores. Updated restaurant wine lists also can be fed into the Personal Sommelier database 12 on a continuous basis to guarantee that consumers can receive predictions on any wine commercially available. Information gathered from a variety of wine websites 22 supplements distributors and retailers wine data 18, 24 and such supplementary information can be directed to the database 12 of the claimed subject matter. Individual consumers can contribute data 14 to the database by using a front-end Personal Sommelier web application to record, e.g., their demographic information and to provide wine ratings on wines that have been consumed by them.

In further embodiments, wine consumers can exchange data with the front-end web application by first supplying, e.g., the following information on wines they have been consumed: wine name; wine varietal; wine vintage; a wine rating (e.g., a wine rating scale where: 4=“Very Satisfied” to 1=“Dissatisfied”) and comments. This consumer information 14 can then be run through statistical processes (discussed in the present application) and the data and the results of the statistical processes can be stored in the Personal Sommelier database 12 for future use.

In a further embodiment, after an individual consumer has provided at least two wine ratings with distinct wine rating values, then the method(s) of the claimed subject matter can provide the consumer with accurate predictions on how they would rate a wine under consideration for purchase or consumption by entering the wine name, varietal and vintage. In the event the consumer has not yet provided two wine ratings with distinct values, then population data matching the demographic information of the consumer can be used.

While this embodiment contemplates, by way of example only, using population data when the consumer has provided less than two wine ratings, the claimed subject matter is not so limited, as it can be within the scope of the claimed subject matter to establish a number “n” of wine ratings, e.g., as a limit where n can be smaller or larger than two. In addition, while this embodiment contemplates using population data when the consumer has provided less than the selected n, e.g., two, wine ratings, it also can be within the scope of the claimed subject matter to use such population data in combination with previously provided consumer data unless otherwise provided by the consumer.

As indicated in the present application, after tasting, drinking or consuming at least some of the wine, the consumer/person can rate or evaluate the wine. In such a case, the wine rating or evaluation can be provided into the database of the claimed subject matter so that such a rating can be factored into future wine analysis. As indicated herein, such rating or evaluating can be performed for each of the one or more identified wines of the identified set of wines that were tasted or consumed or for each of the pre-identified wines that were tasted or consumed.

On the back end, the method(s) of the claimed subject matter pulls characteristics on the wine in question into a consumer's stored regression equation (discussed below) to provide the user with a value, by way of example, between “4” and “1”. This value can represent a prediction as to whether the consumer/person will be “Very Satisfied” to “Dissatisfied” respectively with the wine under consideration. In addition, such method(s) of the claimed subject matter can be configured and arranged so as to also provide a generic binary “Like” or “Dislike” prediction.

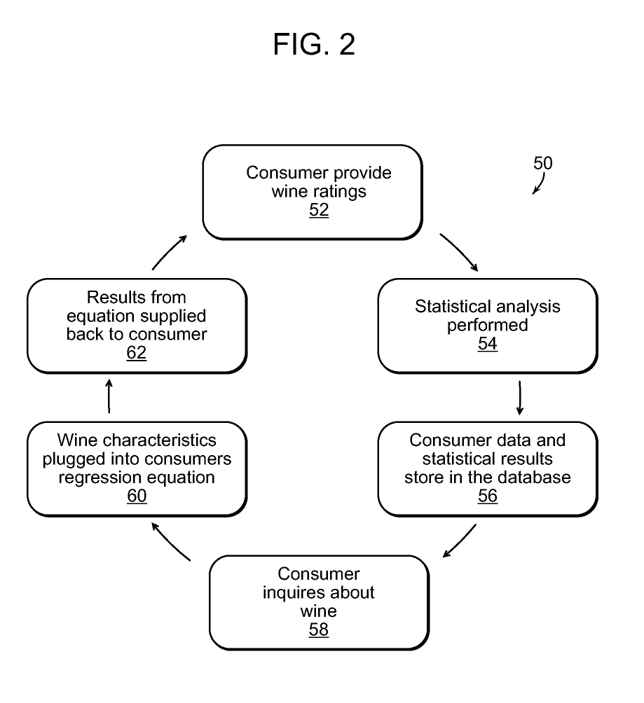

These predictions to the customer/person for a given wine also can be recorded in the database of the claimed subject matter so that when the consumer/person later rates the wine in question, the two values can be compared. If a discrepancy(ies) exist, then the statistical processes can be executed again to recalibrate the user's regression equation. A visual representation of the flow of consumer information can be shown in FIG. 2.

The following is, by way of example, a discussion of the statistical analysis that can be embodied in the methods of the claimed subject matter. It should be recognized that the statistical analysis is not limited to the methodologies described in the present application and such a statistical analysis can be adapted to embody or use other statistical techniques as are known to those skilled in the arts that would be appropriate for use in such methods of the claimed subject matter.

In an embodiment, such methods of the claimed subject matter can use a multiple linear regression and logistic regression to make accurate wine predictions. As indicated in the present application, in an embodiment(s), the analysis uses up to about 340 or more data points that can be stored in the Personal Sommelier database representing, e.g., independent variables (denoted as X₁; X₂; X₃ . . . X₃₄₀) which can act as determinants on which wines an individual consumer will enjoy. As consumers enter wine ratings into the Personal Sommelier database, multiple linear regression analysis can be performed to identify which independent variables result in the wine rating values.

The data points stored in the Personal Sommelier database can include, for example, environmental characteristics, user demographics and wine characteristics. Such environmental characteristics can include, e.g., average monthly temperature (high/low) in the region, highest and lowest temperature in region, average and actual number of hours of sunlight (monthly/annual), soil texture, soil density, and other soil characteristics. Such user demographics can include, e.g., factors such as age, gender, ethnicity, education level, household income, location and wine expertise. Such wine characteristics can include, e.g., alcohol content, type and age of vintage barrel, grape varietal and percentage thereof, location, color of grape and type, type of cork, aroma and taste of wine and food pairing(s).

Each independent variable can be weighted (denoted below as B₁; B₂; B₃ . . . B₃₄₀), e.g., depending upon their influence on the wine rating values. A constant, B₀, can be added to the resulting regression equation so that a prediction yields a value between “4” and “1” (the prediction symbolized as Y-the dependent variable). Thus, the resulting consumer regression equation can be as follows:

Y=B₁X₁+B₂X₂+B₃X₃+ . . . B₃₄₀X₃₄₀+B₀ (Eq. 1)

According to aspects of embodiments of the disclosed subject matter, e.g., a typical consumer could require only four to fifteen independent variables to produce a regression equation which can account for nearly 95% of the variability (adjusted R2 value) in the wine ratings. It should be recognized that a unique regression equation can be provided for each consumer as the number of independent variables, which independent variables and the weight given to each independent variable contributes to a consumer's unique regression equation. A slightly more accurate (98%), but more generic prediction (“Like” versus “Dislike”) can result from, e.g., applying the same independent variables through logistic regression analysis.

For one aspect of the claimed subject matter, in operation wine preference data can be collected from a number of sources, the individual consumer and from the population or population group. In the case of the individual consumer, such data typically involves the consumer providing one or more wine ratings of different wines. In addition, a multitude of data points specific to each wine that can be identified are provided or collected from a number of governmental and industry sources. Subsequently, an analysis using the collected wine preference data and the multitude of data points can be undertaken to provide a listing of wines which can include a prediction for each listed wine as to the acceptability of that wine to the person (, e.g., 4-1, that is, “Very Satisfied” to “Dissatisfied”). This listing with the prediction(s) can be provided to the consumer. Thereafter, the consumer can provide a rating or evaluation of any wine on the list that they consumed or tasted.

When, e.g., the consumer wants to evaluate the acceptability of a specific one or more wines (one or more pre-identified wines) to the consumer, the consumer can identify each of these one or more wines so the analysis to be performed can be limited to these one or more wines. A check also can be undertaken to make sure that the multitude of data points can be available for each of the one or more pre-identified wines. If not, the process also can include uploading or inputting the required information. The analysis can be undertaken to provide a prediction for a pre-identified wine as to the acceptability of that wine to the person (“Very Satisfied” to “Dissatisfied”) and can be provided to the consumer. Thereafter, the consumer can provide a rating or evaluation of any of the one or more pre-identified wines that they consumed or tasted.

The methods of the claimed subject matter can use or utilize wine ratings provided by the individual consumer thus, advantageously allowing for insight into the individual consumer's wine preferences. By identifying the common independent variables (using multiple linear regressions) between wines with similar wine ratings provided from the consumer, such methods of the claimed subject matter can accurately identify other wines with the same characteristics that would produce identical ratings from the consumer. Thus, the methods of the claimed subject matter provide the consumer with accurate predictions on wines based upon desirable characteristics of which the wine consumer may not even be consciously aware, as opposed to the consumer making decisions on wines based on the preferences of human wine experts which in turn may not match the consumer's preferences.

Such methods of the claimed subject matter also can use accessible statistical analysis at the individual consumer level as opposed to population level. By combining consumer provided wine data with environmental and other wine data from multiple, disparate data sources and analyzing the combined data using multiple linear regression and logistic regression, the generated individual consumer regression equations advantageously can yield statistically accurate insight into individual consumer wine preferences. Specifically, the consumer's regression equation can identify for example how many of the 340 independent variables, which of the independent variables, and to what extent each independent variable influences a consumer's proclivity towards any wine. Each consumer regression equation can be unique and specific to the consumer; thus, introducing a new and accessible technique for consumers to identify wines they will likely enjoy.

The methods of the claimed subject matter can advantageously factor and unite a large number of actual and constantly changing environmental, demographic and other variables not previously considered in determining an individual consumer's satisfaction with wine. The interplay of these variables can shed new light on why the consumer prefers one wine over another. Based upon available research, the combination of these variables have not been considered before in identifying enjoyable wines for a consumer; thus, representing a new approach to wine purchasing where consumers can receive accurate predictions from such methods of the claimed subject matter so as to spend their dollars wisely.

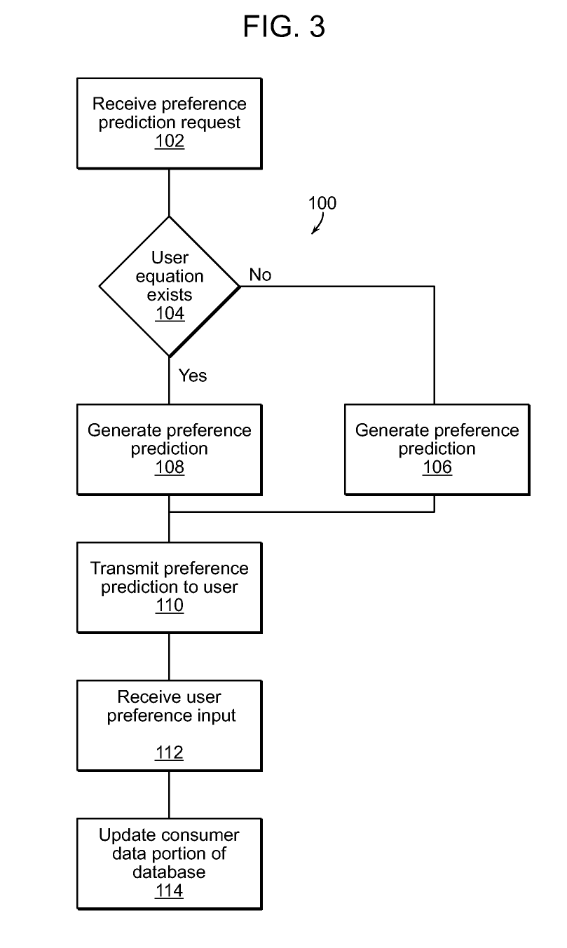

Turning now to FIG. 2 there is shown a block diagram of a process 50 according to aspects of an embodiment of the disclosed subject matter. In block 52 the individual process user, the consumer product consumer, can provide a consumer product, e.g., wine, rating(s) into the system. In block 54, according to certain system rules, discussed in more detail with respect to FIG. 3, the system can perform a statistical analysis, e.g., utilizing data from the personal sommelier database 12 of FIG. 1. The analysis may be personal to the individual user consumer product consumer, e.g., after the user has inputted at least one personal consumer product, e.g., wine, rating and preferably at least two, e.g., for wines given different ratings by the individual user. As an example, the system may save a statistical analysis equation personal to the individual user, and utilize the saved equation for the present statistical analysis, e.g., with a liner regressive algorithm, including the most recent modification to the regression algorithm due to the current input from the individual user. In block 56, this update may be stored in the database in a consumer data and statistical results storage step.

The individual user consumer product consumer may then make a further inquiry about another consumer product, e.g., a wine, in block 58. The system 50 in block 60 may then modify, e.g., the user's personal wine preference algorithm, e.g., with data from the personal sommelier database 12, e.g., specific to the consumer product, i.e., the wine in question, taken from any or all of the portions of the personal sommelier database 12. That is, e.g., consumer product characteristics, e.g., wine characteristic specific to the wine in question may be utilized to update a variable(s) and/or its weighting factor in the personal user statistical analysis equation, e.g., linear regressive analysis equation and then the results of utilizing the algorithm, as modified in block 60 may be presented to the individual user consumer product consumer in block 62 and the user tries, e.g., the wine. The user then inputs a rating for the consumer product, e.g. the wine, in block 52 to start the process 50 all over again.

Turning now to FIG. 3, there is illustrated by way of example a flow chart for a process 100 according to aspects of embodiments of the disclosed subject matter. The proceed 100 can start in block 102 with a receive preference prediction request from an individual user consumer of a consumer product. The user may submit the request, e.g., through a portable personal computing device, such as a smart phone, personal digital assistant or the like having access to the Internet and running, e.g., a personal sommelier application, or accessing such an application, e.g., on a web-site, through the Internet. Upon receipt of the request, e.g., identifying a consumer product, such as a wine, e.g., by brand, type, varietal, vintage, etc. identifying information, or a set of consumer products, e.g., a set of varietals for a given brand of wine, as an example, the process can search, e.g., in the personal sommelier database 12 of FIG. 1 to find, e.g., whether there is an existing statistical prediction equation for the user in inquiry block 104. That is to say, has the user submitted a request in the past and followed that with a consumer product rating, e.g., from 1-4 (dissatisfied to very satisfied), and so has an existing consumer product evaluation equation unique to the specific user product consumer. In some embodiments, the system may be set up to only consider that such an individual consumer product evaluation equation to be in existence after the individual user has submitted some threshold number, e.g., a plurality of, e.g., at least two, consumer product ratings, e.g., wine ratings.

In the event that there is no presently existing stored personal consumer product preference prediction equation determined to be in existence in block 104, then the system can generate a prediction purely on data in the personal sommelier database 12, such as a profile submitted by the individual user, information from the prior rating(s) of the individual user, which amount to less than the selected threshold number, information about the consumer product, e.g., the wine, information about preferences of other statistically similarly situated users, etc. to arrive at the preference prediction in block 106. If the personal preference statistical evaluation equation for the individual user is found to exist, meeting whatever criteria are set for it to be considered to exist in a useable form, in block 104, then the personal preference prediction is made in block 108, using at least the user's personal preference evaluation equation. In some embodiments the prediction of the preference rating can be made solely based upon the individual user statistical personal consumer product preference equation.

In block 110, the individual preference rating prediction can be transmitted to the individual user, again, e.g., over the Internet and, e.g., using a user computing device, e.g., a portable computing/communication device. Once the user consumes the consumer product, e.g., drinks the wine, the user can input a preference rating to the system 100 in block 112, again, e.g., over the Internet. The system can then use the input of the actual individual user consumer product rating to create the individual user consumer product preference prediction equation, if none already exists, or modify such statistical evaluation equation if one already exists in the personal sommelier database 12, and store the created/modified equation unique to the individual user for subsequent use and updating.

The following is a disclosure, by way of example, of what a person of ordinary skill in the art would understand to be a computing device, etc., which may be used with the presently disclosed subject matter. The description of the various components of a computing device, etc. is not intended to represent any particular architecture or manner of interconnecting the components. Other systems that have fewer or more components may also be used with the disclosed subject matter. A communication device may constitute a form of a computing device and may at least include, contain, utilize or emulate a computing device. The computing device may include an interconnect (e.g., bus and system core logic), which can interconnect such components of a computing device to a data processing device, such as a processor(s) or a microprocessor(s) or a controller(s), or other form of partly or completely programmable or pre-programmed device, e.g., hard wired and/or application specific integrated circuit (“ASIC”) customized logic circuitry, such as may implement, e.g., a controller or microcontroller, a digital signal processor, or any other form of device that can fetch and perform instructions, operate on pre-loaded/pre-programmed instructions, and/or follow instructions found in hard-wired or customized circuitry, such as above noted forms of hard-wired circuitry containing logic circuitry, in order to carry out logic operations that, together, perform steps of and whole processes and functionalities as described in the present disclosure.

In this description, various functions, functionalities and/or operations may be described as being performed by or caused by software program code to simplify description. However, those skilled in the art will recognize that what is meant by such expressions is that the functions resulting from execution of the program code/instructions are performed by a computing device as described in the present application, e.g., including a processor, such as a microprocessor, microcontroller, logic circuit or the like noted above. Alternatively, or in combination, the functions and operations can be implemented using special purpose circuitry, with or without software instructions, such as using an Application-Specific Integrated Circuit(s) (ASIC) or a Field-Programmable Gate Array(s) (FPGA), which may be programmable, partly programmable or hard wired. The application specific integrated circuit (“ASIC”) logic may be such as gate arrays or standard cells, or the like, implementing customized logic by metalization(s) interconnects of the base gate array ASIC architecture or selecting and providing metalization(s) interconnects between standard cell functional blocks included in a manufacturer's library of functional blocks, etc. Embodiments can thus be implemented using hard wired circuitry without program software code/instructions, or in combination with circuitry using programmed software code/instructions.

Thus, the techniques are limited neither to any specific combination of hardware circuitry and software, nor to any particular tangible source for the instructions executed by the data processor(s) within the computing device, such as a tangible machine readable medium. In other words, as an example only, part or all of the machine readable medium may in part or in full form a part of the, or be included within the computing device itself, e.g., as the above noted hard wiring or pre-programmed instructions in any memory utilized by or in the computing device.

While some embodiments can be implemented in fully functioning computers and computer systems, various embodiments are capable of being distributed as a computing device including, e.g., a variety of architecture(s), form(s) or component(s). Embodiments may be capable of being applied regardless of the particular type of machine or tangible machine/computer readable media used to actually effect the performance of the functions and operations and/or the distribution of the performance of the functions, functionalities and/or operations.

The interconnect may connect the data processing device to defined logic circuitry including, e.g., a memory. The interconnect may be internal to the data processing device, such as coupling a microprocessor to on-board cache memory, or external (to the microprocessor) memory such as main memory, or a disk drive, or external to the computing device, such as a remote memory, a disc farm or other mass storage device(s), etc. Commercially available microprocessors, one or more of which could be a computing device or part of a computing device, include a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation, as examples.

The inter-connect in addition to interconnecting such as microprocessor(s) and memory may also interconnect such elements to a display controller and/or display device, and/or to other peripheral devices such as an input/output (I/O) device(s), e.g., through an input/output controller(s). Typical I/O devices can include a mouse, a keyboard(s), a modem(s), a network interface(s), a printer(s), a scanner(s), a digital or video camera(s) and other devices which are well known in the art. The interconnect may include one or more buses connected to one another through various forms of a bridge(s), a controller(s) and/or an adapter(s). In one embodiment an I/O controller may include a USB (Universal Serial Bus) adapter for controlling a USB peripheral(s), and/or an IEEE-1394 bus adapter for controlling an IEEE-1394 peripheral(s).

The storage device, i.e., memory may include any tangible machine readable media, which may include but are not limited to recordable and non-recordable type media such as a volatile or non-volatile memory device(s), such as volatile RAM (Random Access Memory), typically implemented as a dynamic RAM (DRAM) which requires power continually in order to refresh or maintain the data in the memory, and a non-volatile ROM (Read Only Memory), and other types of non-volatile memory, such as a hard drive, flash memory, detachable memory stick, etc. Non-volatile memory typically may include a magnetic hard drive, a magnetic/optical drive, or an optical drive (e.g., a DVD RAM, a CD ROM, a DVD or a CD), or other type of memory system which maintains data even after power is removed from the system.

A server could be made up of one or more computing devices. A server can be utilized, e.g., in a network to host a network database, compute necessary variables and information from information in the database(s), store and recover information from the database(s), track information and variables, provide interfaces for uploading and downloading information and variables, and/or sort or otherwise manipulate information and data from the database(s). In one embodiment a server can be used in conjunction with another computing device(s) positioned locally or remotely to execute instructions, e.g., to perform certain algorithms, calculations and other functions as may be included in the operation of the system(s) and method(s) of the disclosed subject matter, as disclosed in the present application.

At least some aspects of the disclosed subject matter can be embodied, at least in part, in programmed software code/instructions. That is, the functions, functionalities and/or operations and techniques may be carried out in a computing device or other data processing system in response to its processor, such as a microprocessor, executing sequences of instructions contained in a memory or memories, such as ROM, volatile RAM, non-volatile memory, cache or a remote storage device. In general, the routines executed to implement the embodiments of the disclosed subject matter may be implemented as part of an operating system or a specific application, component, program, object, module or sequence of instructions usually referred to as a “computer program(s),” or “software.” The computer program(s) typically comprises instructions stored at various times in various tangible memory and storage devices, e.g., in a computing device, such as in cache memory, main memory, internal disk drives, and/or above noted forms of external memory, such as remote storage devices, such as a disc farm, remote memory or databases, e.g., accessed over a network, such as the Internet. When read and executed by a computing device, e.g., by a processor(s) in the computing device, the computer program causes the computing device to perform a method(s), e.g., process and operation steps to execute an element(s) as part of some aspect(s) of the system(s) or method(s) of the disclosed subject matter.

A tangible machine readable medium can be used to store software and data that, when executed by a computing device, causes the computing device to perform a method(s) as may be recited in one or more accompanying claims defining the disclosed subject matter. The tangible machine readable medium may include storage of the executable software program code/instructions and data in various tangible locations as noted above. Further, the program software code/instructions can be obtained from remote storage, including, e.g., through centralized servers or peer to peer networks and the like. Different portions of the software program code/instructions and data can be obtained at different times and in different communication sessions or in a same communication session, e.g., with one or many storage locations.

The software program code/instructions and data can be obtained in their entirety prior to the execution of a respective software application by the computing device. Alternatively, portions of the software program code/instructions and data can be obtained dynamically, e.g., just in time, when needed for execution. Alternatively, some combination of these ways may be used for obtaining the software program code/instructions and data, as an example, for different applications, components, programs, objects, modules, routines or other sequences of instructions or organization of sequences of instructions. Thus, it is not required that the data and instructions be on a single machine readable medium in entirety at any particular instant of time or at any instant of time ever.

In general, a tangible machine readable medium can include any tangible mechanism that provides (i.e., stores) information in a form accessible by a machine (e.g., a computing device), which may be included, e.g., in a communication device, a network device, a personal digital assistant, a mobile communication device, whether or not able to download and run applications from the communication network, such as the Internet, e.g., an I-phone, Blackberry, Droid, or the like, a manufacturing tool, or any other device including a computing device, comprising, e.g., one or more data processors, etc. In an embodiment(s), a user terminal can be a computing device, such as in the form of or included within a PDA, a cellular phone, a notebook computer, a personal desktop computer, etc. Alternatively, any traditional communication client(s) may be used in some embodiments of the disclosed subject matter. While some embodiments of the disclosed subject matter have been described in the context of fully functioning computing devices and computing systems, those skilled in the art will appreciate that various embodiments of the disclosed subject matter are capable of being distributed, e.g., as a system, method and/or software program product in a variety of forms and are capable of being applied regardless of the particular type of computing device machine or machine readable media used to actually effect the distribution.

The disclosed subject matter may be described with reference to block diagrams and operational illustrations or methods and devices to provide the system(s) and/or method(s) according to the disclosed subject matter. It will be understood that each block of a block diagram or other operational illustration (herein collectively, “block diagram”), and combination of blocks in a block diagram, can be implemented by means of analog or digital hardware and computer program instructions. These computing device software program code/instructions can be provided to the computing device such that the instructions, when executed by the computing device, e.g., on a processor within the computing device or other data processing apparatus, the program software code/instructions cause the computing device to perform functions, functionalities and operations of the system(s) and/or method(s) according to the disclosed subject matter, as recited in the accompanying claims, with such functions, functionalities and operations specified in the block diagram.

It will be understood that in some possible alternate implementations, the function, functionalities and operations noted in the blocks of a block diagram may occur out of the order noted in the block diagram. For example, the function noted in two blocks shown in succession can in fact be executed substantially concurrently or the functions noted in blocks can sometimes be executed in the reverse order, depending upon the function, functionalities and operations involved. Therefore, the embodiments of the system(s) and/or method(s) presented and described as a flowchart(s) in the form of a block diagram in the present application are provided by way of example only, and in order to provide a more complete understanding of the disclosed subject matter. The disclosed flow and concomitantly the method(s) performed as recited in the accompanying claims are not limited to the functions, functionalities and operations illustrated in the block diagram(s) and/or logical flow(s) presented in the disclosed subject matter. Alternative embodiments are contemplated in which the order of the various functions, functionalities and operations may be altered and in which sub-operations described as being part of a larger operation may be performed independently or performed differently than illustrated or not performed at all.

Although some of the drawings may illustrate a number of operations in a particular order, functions, functionalities and/or operations which are not now known to be order dependent, or become understood to not be order dependent, may be reordered. Other functions, functionalities and/or operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The disclosed subject matter is described in the present application with reference to one or more specific exemplary embodiments thereof. Such embodiments are provided by way of example only. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense. Numerous variations, changes, and substitutions will now occur to those skilled in the art without departing from the disclosed subject matter. It should be understood that various alternatives to the embodiments of the disclosed subject matter described as part of the disclosed subject matter may be employed in practicing the disclosed subject matter. It is intended that the following claims define the scope of the disclosed subject matter and that methods and structures within the scope of these claims and their equivalents be covered by the following claims.

The figures and discussion herein concerning the methods of the claimed subject matter illustrate the structure of the logic of the claimed subject matter as embodied in computer program software for execution on a computer, digital processor or microprocessor. Those skilled in the art will appreciate that the figures and discussion illustrate, by way of example, the structures of the computer program code elements, including logic circuits on an integrated circuit, that function according to the claimed subject matter. As such, the claimed subject matter can be practiced in its essential embodiment(s) by a machine component that renders the program code elements in a form that instructs a digital processing apparatus (e.g., computer) to perform a sequence of function step(s) corresponding to those shown in the flow diagrams, i.e., a machine readable medium storing instructions which, when executed by the computing device, performs a method(s) as defined in the present application.

Although at least one preferred embodiment of the claimed subject matter has been described using specific terms, such description is for illustrative purposes only, and it is to be understood that changes and variations may be made without departing from the spirit or scope of the following claims.

### EQUIVALENTS

Those skilled in the art will recognize, or be able to ascertain using no more than routine experimentation, many equivalents of the specific embodiments of the claimed subject matter described herein. Such equivalents are intended to be encompassed by the following claims.

What is claimed is:

1. A method for predicting the preference of an individual user product consumer for a consumer product comprising the steps of:
collecting in a consumer product preference data database, via a computing device, consumer product preference data relating to the prediction of a preference of the individual user product consumer for the consumer product from at least one of the individual user product consumer and a separate group of individual product consumers;
receiving, via the computing device, from the individual user product consumer a request for a prediction of the preference of the individual user product consumer for one of a consumer product and a pre-selected set of related consumer products;
analyzing, via the computing device, the collected consumer product preference data against previously collected data specific to one of the consumer product and the pre-selected set of consumer products;
calculating, via the computing device, a prediction of a preference rating for the individual user product consumer as to the preference of the individual user product consumer for the one of the consumer product and the preselected set of consumer products; and
receiving and storing, via the computing device, a preference rating for the individual user product consumer based upon the individual user product consumer having utilized the one of the consumer product and the pre-selected set of consumer products and including the received individual user product consumer preference rating in the consumer product preference data.

2. The method of claim 1 further comprising:
the consumer product comprising a wine.

3. The method of claim 1 further comprising:
calculating, via a computing device, comprises utilizing a statistical individual user consumer product preference evaluation equation unique to the individual user product consumer.

4. The method of claim 3 further comprising:
including the received individual user product consumer preference rating into the consumer product preference data comprising updating the individual user consumer product preference evaluation equation unique to the individual user product consumer.

5. The method of claim 1, wherein at least some of the consumer product preference data collected in the consumer product preference data database is obtained through a website application.

6. The method of claim 1, wherein the consumer product preference data comprises one of individual user consumer product preference data unique to the individual user product consumer and data obtained from a population group of consumer product consumers.

7. A method of claim 3, further comprising:
the individual user consumer product preference evaluation equation comprising a linear regression analysis equation.

8. The method of claim 1 further comprising:
the consumer product preference data database comprising a cloud-based relational database.

9. The method of claim 8 further comprising:
the relational database comprising data specific to each of the one or more pre-identified consumer products.

10. The method of claim 9 further comprising:
the relational database comprising data input from at least one of a source of consumer data, producer data, distributor data, government data, internet data and retailer data.

11. A system for predicting the preference of an individual user product consumer for a consumer product comprising:
a computing device configured to:
collect in a consumer product preference data database consumer product preference data relating to the prediction of a preference of the individual user product consumer for the consumer product from at least one of the individual user product consumer and a separate group of individual product consumers;
receive from the individual user product consumer a request for a prediction of the preference of the individual user product consumer for one of a consumer product and a pre-selected set of related consumer products;
analyze the collected consumer product preference data against previously collected data specific to one of the consumer product and the pre-selected set of consumer products;
calculate a prediction of a preference rating for the individual user product consumer as to the preference of the individual user product consumer for the one of the consumer product and the preselected set of consumer products; and
receive and store a preference rating for the individual user product consumer based upon the individual user product consumer having utilized the one of the consumer product and the pre-selected set of consumer products and including the received individual user product consumer preference rating into the consumer product preference data.

12. The system of claim 11 further comprising:
the consumer product comprising a wine.

13. The system of claim 11 further comprising:
the computing device configured to calculate utilizing a statistical individual user consumer product preference evaluation equation unique to the individual user product consumer.

14. The system of claim 13 further comprising:
the computing device configured to include the received individual user product consumer preference rating into the consumer product preference data by updating the individual user consumer product preference evaluation equation unique to the individual user product consumer.

15. The system of claim 11, wherein at least some of the consumer product preference data collected in the consumer product preference data database is obtained through a website application.

16. The system of claim 11, wherein the consumer product preference data comprises one of individual user consumer product preference data unique to the individual user product consumer and data obtained from a population group of consumer product consumers.

17. A system of claim 13, further comprising:
the individual user consumer product preference evaluation equation comprising a linear regression analysis equation.

18. The method of claim 11 further comprising:
the consumer product preference data database comprising a cloud-based relational database.

19. The method of claim 18 further comprising:
the relational database comprising data specific to each of the one or more pre-identified consumer products.

20. A machine readable medium storing instructions which, when executed by a computing device, cause the computing device to perform a method, the method comprising:
collecting in a consumer product preference data database consumer product preference data relating to the prediction of a preference of the individual user product consumer for the consumer product from at least one of the individual user product consumer and a separate group of individual product consumers;
receiving from the individual user product consumer a request for a prediction of the preference of the individual user product consumer for one of a consumer product and a pre-selected set of related consumer products;
analyzing the collected consumer product preference data against previously collected data specific to one of the consumer product and the pre-selected set of consumer products;
calculating a prediction of a preference rating for the individual user product consumer as to the preference of the individual user product consumer for the one of the consumer product and the preselected set of consumer products; and
receiving and storing a preference rating for the individual user product consumer based upon the individual user product consumer having utilized the one of the consumer product and the pre-selected set of consumer products and including the received individual user product consumer preference rating into the consumer product preference data.
